(19) United States
(12) Patent Application Publication
(10) Pub. No.: US 2007/0038741 A1
(43) Pub. Date: Feb. 15, 2007

(54) Automatically adding an IP address of DNA to a list of instruments displayed to a user by a downloaded instrument management application

(76) Inventor: Matthew James Gerholdt, Security, CO (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/202,060

(22) Filed: Aug. 12, 2005

(51) Int. Cl. G06F 15/173

(52) U.S. Cl. 709/224

(57) ABSTRACT

A user downloads an instrument management application from a distributed network analyzer, which is an instrument managed by the instrument management application and has an internet protocol address. The distributed network analyzer sends a message, including the internet protocol address of the distributed network analyzer, to the instrument management application. Then, the instrument management application contacts the distributed network analyzer to thereby gather other identification information of the distributed network analyzer. The instrument management application automatically adds the internet protocol address, along with the other identification information, to a list of instruments displayed to the user of the downloaded instrument management application by the downloaded instrument management application.

### DESCRIPTION OF THE RELATED ART

Distributed Network Analyzers (DNAs) are used to analyze networks by providing testing and measurement capabilities. DNAs are used, for example, for diagnosing problems and troubleshooting networks.

However, there is a need for an effective instrument management application for managing DNAs.

### BRIEF DESCRIPTION OF THE DRAWINGS

Aspects and advantages of the present invention will become apparent and more readily appreciated from the following description of the preferred embodiments, taking in conjunction with the accompanying drawings of which:

FIG. 1 is a diagram showing a DNA with an instrument management application and a remote computer with a list of instruments managed by an instrument management application.

FIG. 2 is a flowchart illustrating a process of downloading an application from a DNA and automatically adding a DNA to a list displayed by the downloaded application, according to an embodiment of the present invention.

FIG. 3 is a flowchart illustrating, in detail, a process of automatically adding the IP address of a DNA to the list displayed by the downloaded application, according to an embodiment of the present invention.

FIG. 4 is a flowchart illustrating a process of listening for other messages from a DNA, according to an embodiment of the present invention.

FIG. 5 is a screenshot before downloading an instrument management application begins, according to an embodiment of the present invention.

FIG. 6 is a screenshot of an empty list displayed by a downloaded instrument management application, according to an embodiment of the present invention.

FIG. 7 is a screenshot of a list, displayed by a downloaded instrument management application, showing identification information of a DNA, according to an embodiment of the present invention.

FIG. 8 is a diagram illustrating an apparatus for downloading an instrument management application and displaying an automatically added IP address in a list of instruments, according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

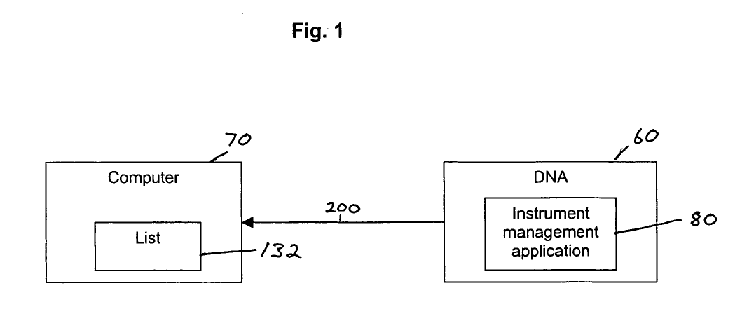

FIG. 1 is a diagram showing a DNA with an instrument management application and a remote computer with a list of instruments managed by an instrument management application. Referring now to FIG. 1, a computer 70 downloads an instrument management application 80 from a DNA 60 to computer 70, as indicated by line 200. The instrument management application is run by computer 70 and displays the list 132 of instruments managed by the downloaded instrument management application 80.

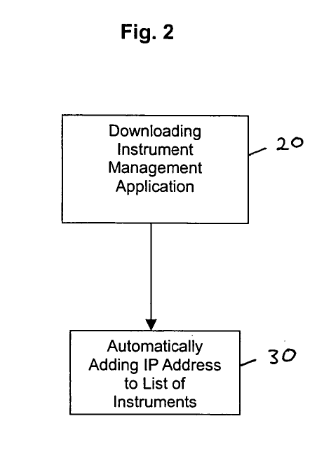

FIG. 2 is a flowchart illustrating a process of downloading the instrument management application 80 from the DNA 60 and automatically adding the DNA 60 to the list 132 displayed by the downloaded instrument management application 80, according to an embodiment of the present invention. Referring now to FIG. 2, in operation 20, the instrument management application 80 is downloaded from the DNA 60. DNA 60 is an instrument managed by the instrument management application 80 and has an internet protocol (IP) address.

From operation 20, the process moves to operation 30, where the IP address of the DNA 60 is automatically added to the list 132 of instruments displayed to a user of the downloaded instrument management application 80 by the downloaded instrument management application 80. Herein, the term “automatically” indicates an operation performed by a computer, without human intervention. For example, the operation is performed in an automated manner by a computer via computer processing.

Although FIGS. 1 and 2 describe an instrument management application being downloaded from a DNA, the present invention is not limited to downloading from a DNA, but applies to downloading from any server. Moreover, it is not necessary that the server is previously determined or centralized before the application is downloaded from the server.

Furthermore, the present invention is not limited to downloading an instrument management application, but is applicable when downloading other types of applications.

Moreover, the present invention is not limited to any particular manner of downloading.

In embodiments of the present invention, a remote computer, such as the computer 70, might run software to manage a plurality of DNAs. In such embodiments, a plurality of instrument management applications 80 would be downloaded from a plurality of DNAs 60, respectively. Each downloaded instrument management application 80 might be, for example, a small Java application for managing the associated DNA 60. However, the present embodiment is not limited to a Java application. Each downloaded instrument management application 80 would automatically add the IP address of the associated DNA 60 to a list of instruments displayed by the computer 70 and managed by the software running on the computer 70.

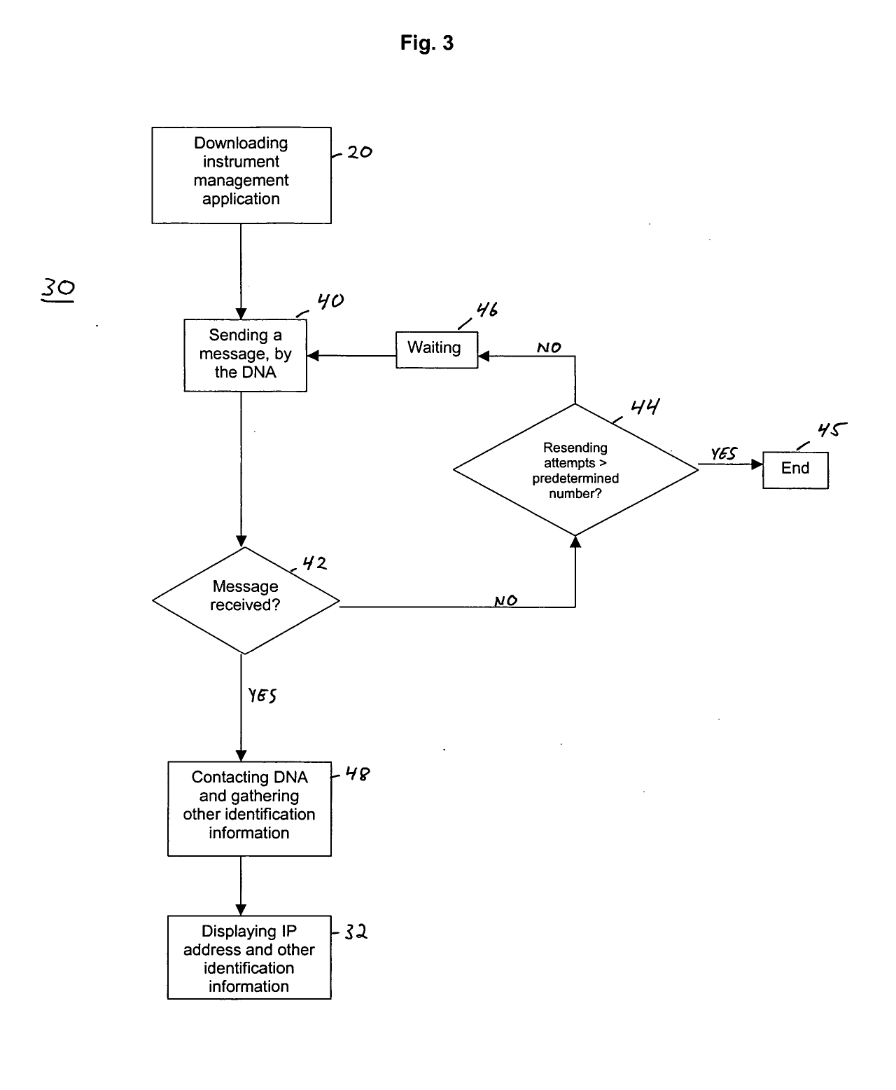

FIG. 3 is a flowchart illustrating, in detail, a process of automatically adding the IP address of the DNA 60 to the list 132 displayed by the downloaded instrument management application 80, according to an embodiment of the present invention. Specifically, FIG. 3 is a flowchart illustrating operation 30, of FIG. 2, in greater detail. Referring now to FIG. 3, in operation 40, the DNA 60 sends a message, including the IP address of the DNA 60, to the downloaded instrument management application 80 on computer 70. Operation 40 is performed after downloading the instrument management application 80 from the DNA 60, as shown in operation 20 of FIG. 2. The DNA 60 determines the IP address of the computer 70 to which the instrument management application 80 is downloaded.

The present invention is not limited to any particular type of computer to which an instrument management application is downloaded, and multiple computers can download the instrument management application simultaneously.

The message sent in operation 40 is, for example, a hypertext transfer protocol (http) message. However, the present invention is not limited to http messages.

The downloaded instrument management application 80 on computer 70 saves the list 132 on computer 70 as, for example, an .XML file. However, the present invention is not limited to saving the list 132 as an .XML file.

From operation 40, the process moves to operation 42, where the DNA 60 determines if the message is received by the downloaded instrument management application 80. If the message is not received by the downloaded instrument management application (i.e. the connection to the downloaded instrument management application 80 is refused for any reason) in operation 40, then the DNA 60 attempts to resend the message. In that case, the process moves to operation 44, where the DNA 60 keeps track of the number of resending attempts, and if the number of resending attempts is greater than the predetermined maximum number, then the process moves to operation 45, where the DNA 60 gives up and does not resend the message.

If the number of resending attempts is less than or equal to the predetermined maximum number in operation 44, then the process moves to operation 46 where the DNA 60 waits for a predetermined period of time before the process returns to operation 40 where the DNA 60 then resends the message.

From operation 42, if the message is received by the downloaded instrument management application 80, the process moves to operation 48, where the downloaded instrument management application contacts the DNA 60 and thereby gathers other identification information of the DNA 60.

From operation 48, the process moves to operation 32, where the IP address of the DNA 60, along with the other identification information, is displayed in the list 132 of instruments managed by the downloaded instrument management application 80. The other identification information may include, but is not limited to, the DNA type, the internal network interface and the hostname.

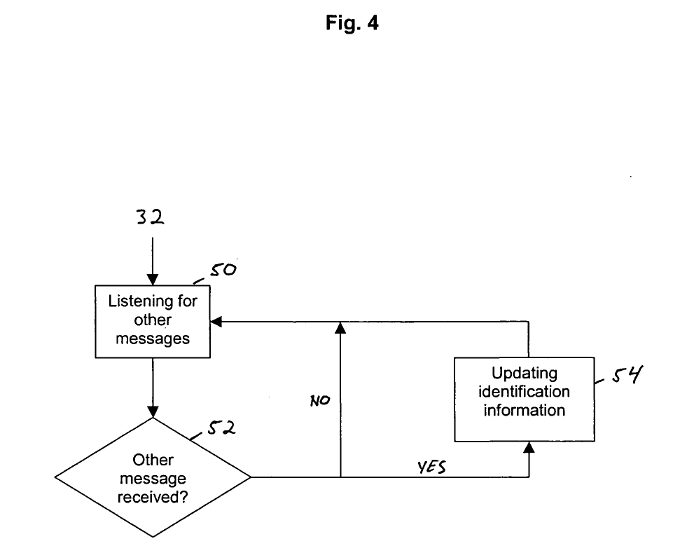

FIG. 4 is a flowchart illustrating a process of listening for other messages from the DNA 60, according to an embodiment of the present invention. Referring now to FIG. 4, after operation 32, shown in FIG. 3, the process moves to operation 50, where the downloaded instrument management application 60 listens for other messages from the DNA 60 to thereby detect other messages.

From operation 50, the process moves to operation 52, where the downloaded instrument management application 80 determines whether other messages from the DNA 60 have been received by the downloaded instrument management application 80.

From operation 52, if a message is received by the downloaded instrument management application 80, the process moves to operation 54, where the downloaded instrument management application 80 updates the identification information of the DNA 60 in the displayed list 132, in accordance with the information contained in the detected message.

If no other message is received by the downloaded instrument management application 80 in operation 52, then the process moves from operation 52 back to operation 50, where the downloaded instrument management application 80 continues to listen for other messages.

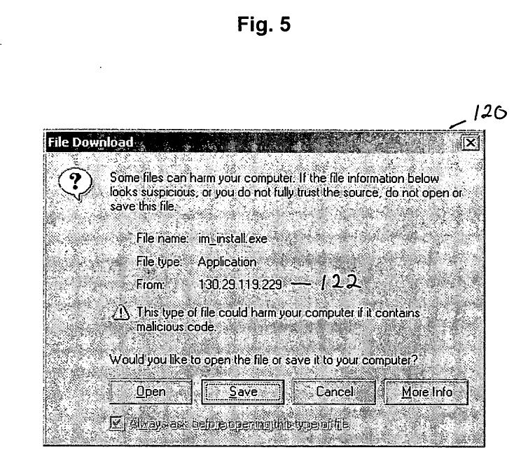

FIG. 5 is a screenshot before downloading the instrument management application 80 begins, according to an embodiment of the present invention. Referring now to FIG. 5, a File Download box 120 appears before downloading of the instrument management application 80 from the DNA 60 begins. The File Download box 120 indicates the IP address 122 of the DNA 60 from which the instrument management application 80 will be downloaded. The present invention not limited to a particular configuration of the File Download box, and the File Download box may contain other identification information of the DNA from which the instrument management application is downloaded.

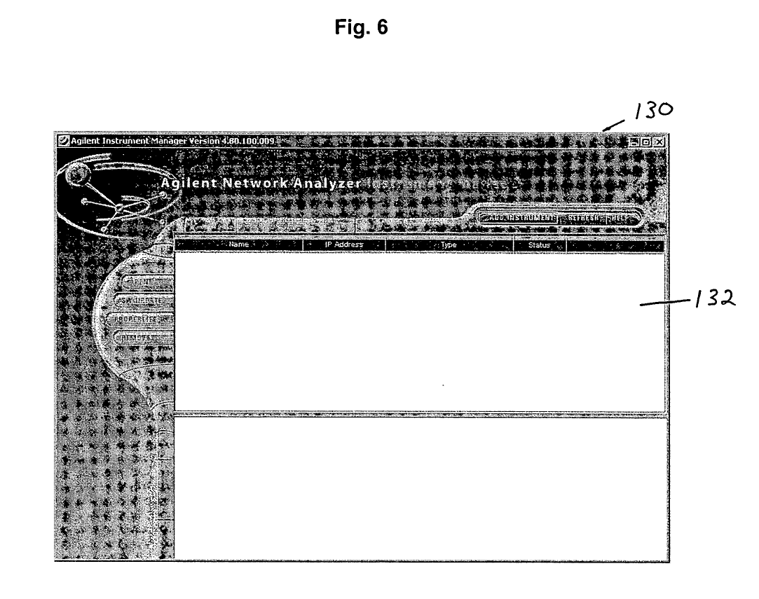

FIG. 6 is a screenshot of an empty list 132 displayed by the downloaded instrument management application 80, according to an embodiment of the present invention. Referring now to FIG. 6, the instrument management application screenshot 130 is shown before automatically adding the IP address 122 of the DNA 60, as shown in operation 30 of FIG. 2. The list 132 of instruments displayed to a user of the downloaded instrument management 80, as described by the present invention, is not limited to a specific configuration.

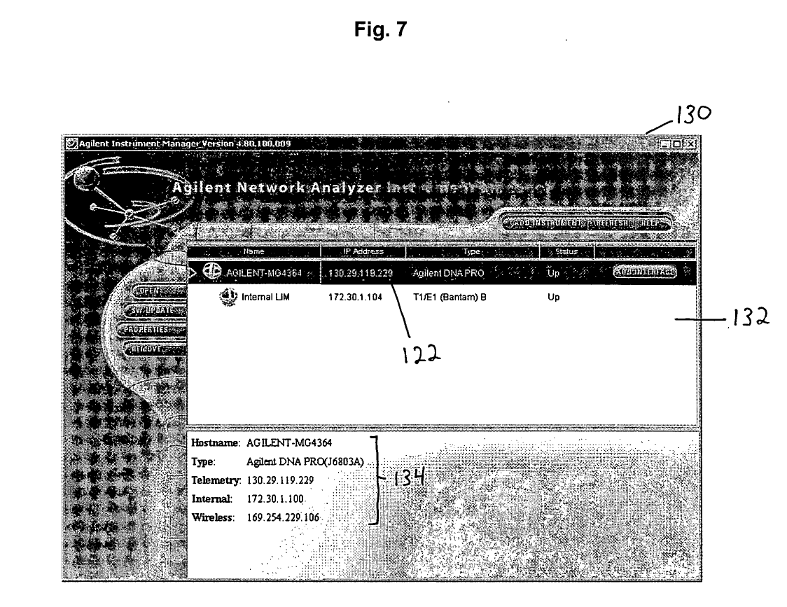

FIG. 7 is a screenshot of a list, displayed by the downloaded instrument management application 80, showing identification information of the DNA 60, according to an embodiment of the present invention. Referring now to FIG. 7, the instrument management application screenshot 130 is shown, where the list 132 of instruments displays the IP address 122 of the DNA 60 from which the instrument management application was downloaded.

Other identification information 134 is also displayed, including the hostname, DNA type, internal network interface, etc. The present invention is not limited to displaying only the information depicted in FIG. 6, but could display any identification information of the DNA 60 that is gathered by the instrument management application 80 in operation 48.

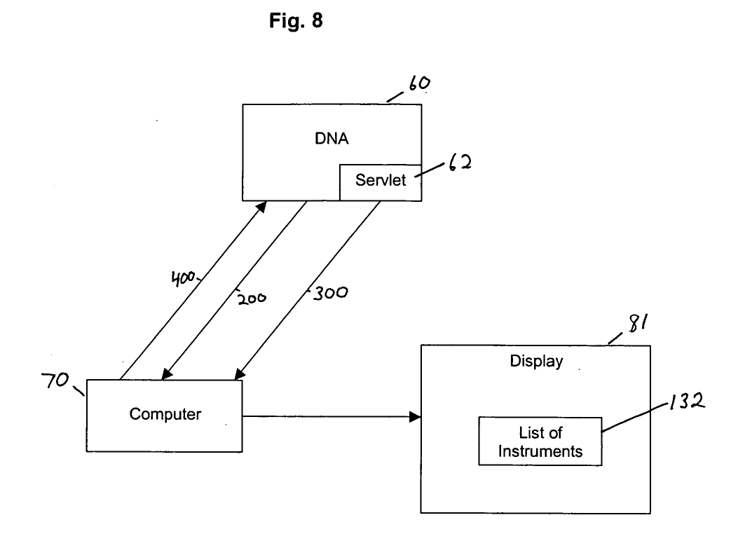

FIG. 8 is a diagram illustrating an apparatus for downloading an instrument management application and displaying an automatically added IP address in a list of instruments, according to an additional embodiment of the present invention. Referring now to FIG. 8, an instrument management application is downloaded to a computer 70 from a DNA 60, as indicated by communication line 200, where the DNA 60 is an instrument managed by the instrument management application and has an IP address. As stated above, the present invention is not limited to an instrument management application or a DNA. The present invention can be applied to other types of applications downloaded from a server.

When the instrument management application is downloaded, the DNA 60 stores the IP address of the computer 70 to which the instrument management application is downloaded.

When the instrument management application is installed in the computer 70, the instrument management application receives a message sent from a servlet 62, within the DNA 60, as indicated by communication line 300. The message includes the IP address of the DNA 60. The downloaded instrument management application 80 gathers other identification information of the DNA 60, as indicated by communication line 400.

The downloaded instrument management application 80 automatically adds the IP address, as well as the other gathered identification information of the DNA 60, to a list 132 of instruments displayed to a user on a display 81, by the downloaded instrument management application 80. There are many different types of displays which may be used to display information from a computer, and the present invention is not limited to a specific type of display. Furthermore, the computer 70 of the present invention is not limited to being any specific type of computer. Instead, computer 70 could include any information processing device capable of communicating with the DNA 60.

Various embodiments of the present invention provide a method and apparatus for identifying a DNA from which an instrument management application is downloaded in a list of instruments displayed to a user of a downloaded instrument management application by the downloaded instrument management application.

The various embodiments of the present invention provide a method which includes downloading an instrument management application from a DNA. The DNA is an instrument managed by the instrument management application and has an internet protocol (IP) address. The method further includes automatically adding the IP address to a list of instruments displayed to a user of the downloaded instrument management application by the downloaded instrument management application.

The various embodiments of the present invention further provide an apparatus including a computer which downloads an instrument management application from a DNA. The DNA is an instrument managed by the instrument management application and has an IP address. The computer automatically adds the IP address of the DNA to a list of instruments. The list of instruments is displayed to a user of the downloaded instrument management application by the downloaded instrument management application.

The various embodiments of the present invention also provide a method which includes downloading an instrument management application from a DNA. The DNA is an instrument managed by the instrument management application and has an IP address. The method includes sending a message, by the DNA, including the IP address of the DNA, to the downloaded instrument management application. If sending the message to the downloaded instrument management application is unsuccessful, the DNA resends the message a predetermined number of times or until the message is received by the downloaded instrument management application. The DNA waits for a predetermined period before each time the message is resent. The method also includes automatically adding the IP address included in the message sent to the downloaded DNA to a list of instruments displayed to a user of the downloaded instrument management application by the downloaded instrument management application. The instrument management application listens for other messages from the DNA to thereby detect the other messages, and updates identification information of the DNA in the displayed list in accordance with information contained in the detected messages.

The various embodiments of the present invention also provide a method and apparatus for downloading an instrument management application from a DNA to a remote computer, and running the downloaded instrument management application on the remote computer to thereby manage the DNA from the remote computer.

The various embodiments of the present invention also include an apparatus including a remote computer for downloading an instrument management application from a DNA and running the downloaded instrument management application to thereby manage the DNA from the remote computer.

Although the preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method comprising:
downloading an instrument management application from a distributed network analyzer (DNA), the DNA being an instrument managed by the instrument management application and having an internet protocol (IP) address; and
automatically adding the IP address to a list of instruments displayed to a user of the downloaded instrument management application by the downloaded instrument management application.

2. The method of claim 1 wherein said automatically adding comprises:
sending a message, by the DNA, including the IP address of the DNA to the downloaded instrument management application, wherein the sent IP address is the IP address added to the list.

3. The method of claim 2 further comprising:
if sending the message to the downloaded instrument management application is unsuccessful, resending the message by the DNA a predetermined number of times or until the message is received by the downloaded instrument management application.

4. The method of claim 3 further comprising:
waiting, by the DNA, for a predetermined period of time before each time the message is resent.

5. The method of claim 2 further comprising:
contacting the DNA and thereby gathering other identification information of the DNA; and
automatically adding said other identification information to the displayed list.

6. The method of claim 1 further comprising:
listening for other messages from the DNA to thereby detect other messages; and
updating identification information of the DNA in the displayed list in accordance with information contained in the detected messages.

7. An apparatus comprising:
means for downloading an instrument management application from a distributed network analyzer (DNA), the DNA being an instrument managed by the instrument management application and having an internet protocol (IP) address; and
means for automatically adding the IP address to a list of instruments displayed to a user of the downloaded instrument management application by the downloaded instrument management application.

8. A method comprising:
downloading an instrument management application from a distributed network analyzer (DNA), the DNA being an instrument managed by the instrument management application and having an internet protocol (IP) address;
sending a message, by the DNA, including the IP address of the DNA to the downloaded instrument management application, wherein said sending a message comprises
if sending the message to the downloaded instrument management application is unsuccessful, resending the message by the DNA a predetermined number of times or until the message is received by the downloaded instrument management application, and
waiting, by the DNA, for a predetermined period before each time the message is resent;
contacting the DNA and thereby gathering other identification information of the DNA;
automatically adding the IP address included in the message sent by the DNA and the other identification information of the DNA to a list of instruments displayed to a user of the downloaded instrument management application by the downloaded instrument management application;
listening for other messages from the DNA to thereby detect the other messages; and
updating identification information of the DNA in the displayed list in accordance with information contained in the detected messages.

9. A method comprising:
downloading an instrument management application from a distributed network analyzer (DNA) to a remote computer; and
running the downloaded instrument management application on the remote computer to thereby manage the DNA from the remote computer.

10. An apparatus comprising:
means for downloading an instrument management application from a distributed network analyzer (DNA) to a remote computer; and
means for running the downloaded instrument management application on the remote computer to thereby manage the DNA from the remote computer.
